(19) United States
(12) Patent Application Publication
(10) Pub. No.: US 2012/0034375 A1
(43) Pub. Date: Feb. 9, 2012

(54) MOULDED, MODULAR BUILDING

(76) Inventor: Charles Caulder Bree, Mercer (NZ)

(21) Appl. No.: 13/120,844

(22) PCT Filed: Sep. 24, 2009
(86) PCT No.: PCT/NZ2009/000201

§ 371 Date: Oct. 26, 2011

(30) Foreign Application Priority Data
Sep. 24, 2008 (NZ) 571527

(51) Int. Cl. B29C 70/32

(52) U.S. Cl. 427/183

(57) ABSTRACT

A single-axis rotational moulding apparatus conveniently forms planar or curved three-dimensional shapes of plastics, suitable as modules for buildings. An erectable, demountable building made of such modules may be shipped in the disassembled state and then erected by untrained personnel on a site. The modules may be made of wood or plastics. Preferred modules are made by rotational moulding and include insulation-filled cavities serving as thermal insulation. A further oven is used to fabricate large cylinders. After removal the hot cylinders are flattened into sheets of plastics material for use as flooring.

### FIELD

This invention relates to buildings, to buildings made by moulding sections out of plastics materials, and then assembling the buildings, and to methods for moulding the sections.

### DEFINITIONS

Rotationally moulded structures are made by a process in which granules of at least one type of fusible plastics material are introduced into a hollow mould which is heated, while the mould is moved about—normally rotated in two perpendicular axes, and during this time the granules stick to the inner walls of the mould. The mould is then cooled and disassembled, and the substantially finished article, usually including a central void, is removed.

### BACKGROUND

The inventor has previously published (as PCT/NZ2008/000096) a variant process in which granules are continuously introduced into a mould that is rotated in one axis, during which time the mould is maintained in a hot state, and it is possible to form an outer coherent and impermeable skin, surrounding an inner discontinuous yet fused layer, on the resulting object. Rotationally moulded buildings made of a plastics material are considered to be difficult to make, owing to the size of the moulds involved, yet the above method produces product comprising a round building with a roof, moulded as a single unit, with a separate circular floor. However an application for such buildings that can be used in a cold climate prompted the inventor to produce a version having a substantially improved insulation (R) value and as a result, another approach to provision of moulded buildings has been developed.

### OBJECT

The object of this invention may be stated as to provide a method and apparatus for making components for buildings; also the components and assembled buildings made of plastics materials, or at least to provide the public with a useful choice.

### STATEMENT OF INVENTION

In a first broad aspect this invention provides apparatus for making a plurality of components by rotational moulding of a granular, flowable, fusible plastics material with heat in an oven characterised in that the apparatus includes single-axis rotational means only, and includes at least one openable mould rotatable inside a heatable oven in a single axis, the mould being supported in a frame and shaped so as to form a three-dimensional component that is a replica of the mould interior, the shape of the interior of each mould, in combination with a selected axis of rotation being calculated and limited so that all parts of the interior of the mould have a substantially similar chance of becoming coated with an evenly distributed amount of the fusible plastics material, despite the apparatus being restricted to just a single axis of rotation.

In an alternative aspect, the invention provides an apparatus for making components for buildings; the apparatus comprising a mould or family of moulds used in accordance with a modified rotational moulding process, wherein components having three-dimensional shapes are produced in moulds rotated in only one dimension and wherein each component is adapted for assembly with other components according to the invention in order to create a building having walls and a roof and doors.

In a subsidiary aspect, the invention provides apparatus as previously described in this section wherein the position of the axis of rotation is adjusted with regard to the internal shape of the mould so that the distance that the granular material would flow from the axis of rotation to any extremity of the mould is similar.

In another subsidiary aspect, the invention provides apparatus as previously described in this section wherein the mould includes an axial conduit capable of receiving the granular fusible plastics material while the mould is undergoing rotation, in order that further material, or material of a different composition, may be introduced into the mould after moulding has commenced.

In a further subsidiary aspect, the invention provides apparatus as previously described in this section wherein the mould or family of moulds are shaped so as to produce thin three-dimensional moulded components having a first flattened area merged along an edge into a second flattened area; each flattened area being thin yet including a contiguous thermally insulating core; the core being surrounded on every side by an impervious layer.

Optionally, the flattened areas are not flat but are curved.

In a further subsidiary aspect, the invention provides apparatus as previously described in this section wherein one flattened area includes a framed rectangular aperture.

In another aspect, the invention provides apparatus as previously described in this section wherein the mould or family of moulds are shaped so as to provide thin moulded components each having complementary interconnecting means along at least two opposite edges, said inter connecting means of any one component being capable of becoming fastened to the interconnecting means of other compatible components.

Preferably the interconnecting means comprises a complementary pair of lapped joints by means of which adjacent modules may be connected together.

In a related aspect, the invention provides a moulded component selected from a range including (a) a plain, straight-wall module, (b) a plain, curved-wall module, (c) a straight-wall module including a door opening, (d) a straight-wall module including a window opening, and (e) a curved-wall module including a window opening; the range providing components capable of being assembled together by interconnecting means.

Preferably the curved modules are shaped so that they may be connected against each other and form a hemicircular end wall.

In a second major aspect the invention provides apparatus for making large flat components by rotational moulding of a granular fusible plastics material with heat in an oven characterised in that the apparatus includes single-axis rotational moulding means only; the mould comprises a cylindrical shape capable of being rotated about the axis of the cylinder when inside the closed, heated oven and thereby forming a cylindrical fused mass from introduced fusible granular plastics material; the apparatus also including removal means comprising a moveable cylindrical frame capable of carrying, supported by the exterior of the cylinder, a formed cylinder of plastics material away from the oven whereupon the cylinder may be cut apart while hot and laid flat before cooling takes place.

Alternatively, the hot cylinder upon the frame may be left to cool while held upon the frame, and then may be cut apart after cooling and used in the form of a plurality of curved sectors

In a third major aspect the invention provides a building made from assembled, moulded components as previously described in this section; namely a selection of three-dimensional interconnectable components and flat or curved components; the flat components serving as flooring.

Preferably the building is comprised of a plurality of modules—of which there are about 7 types of module; not including roof ventilation components.

In a further broad aspect the invention provides an assembly device comprising a threaded screw adapted for securing one section of a moulded structure to another.

### PREFERRED EMBODIMENT

The description of the invention to be provided herein is given purely by way of example and is not to be taken in any way as limiting the scope or extent of the invention.

Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

### DRAWINGS

FIG. 1: is a perspective view of a moulding oven according to the invention, having a single axis of rotation.

FIG. 2: is an exploded view of a house showing the moulded modules as separate items.

FIG. 3: is a perspective drawing showing an example completed building, including optional straight modules along each side.

FIG. 4: is an elevation view from the exterior of a single type (a) module, including an exposed joint assembly.

FIG. 5: is a cross section of a single module.

FIG. 6: is a cross section through a joint showing fasteners in place.

FIG. 7: shows details of the pre-drilled perforations in a joint.

FIG. 8: shows details of roof cap members.

FIG. 9: shows details of a jointing screw.

FIG. 10: shows aspects of a moulding oven according to the invention, having a single axis of rotation, used for making sheets of rotationally moulded plastics material.

FIG. 11: shows a cross-section through a frame to be used on a forklift to lift hot cylinders of rotationally moulded plastics material out of the oven of FIG. 10.

The reader is assumed to be familiar with use of rotational moulding, as used to make a plastics kayak, for example. The contents of the applicant's previous patent, PCT/NZ2008/000096 are to be considered as included herein. The principal example to be described herein is a building, while other structures may be constructed from modules according to the same general principles.

### EXAMPLE 1

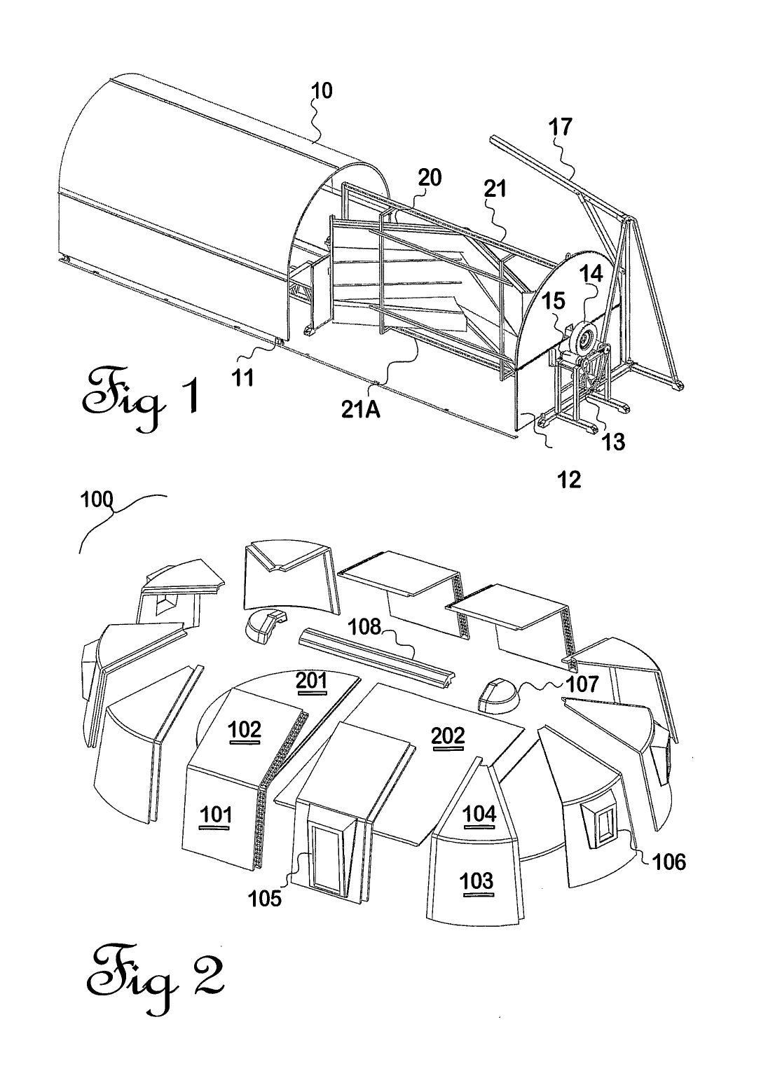

The inventor has made improvements to the apparatus and process of rotational moulding in order to construct multi-part objects. FIG. 1 shows the principles of the apparatus:

The principles are based on use of an oven with a tilting mould carrier that rotates in one axis only—a horizontal axis including the drive wheel 14 and a second pivot (obscured) at the other end of the mould frame 21, that swings the mould around that axis while it is being heated, all as shown in FIG. 1. Here 10 is a removable, thermally insulating cover that can be wheeled up to the mould and serves to contain heat during formation of the object; 11 is a rail assembly to support the cover mounted on the underlying earth or preferably a concrete floor, and 12 is an end frame that supports the rotating mould and drive assembly during moulding. 13 is an electric motor; preferably reversible, that, by means of a “V” belt, drives two support rollers 15 by means of which a supported drive wheel 14 (typically a small rubber tyred wheel) that is connected to the axis of the mould 20 within its supporting framework is driven. The mould 20 is an openable, re-usable mould for making any specific desired shape. Frame 17 is used for lifting the mould in its frame from the oven, especially when hot, so that it can be opened and the contents released. A heating means is not shown, but comprises means well known to those skilled in the art, such as one or two gas burners operating near the lowest interior surface of the oven. The heating means is sufficient to heat the space inside the closed cover 10 to raise the temperature to the fusing point of the selected fusible plastics material. The electric motor 13 is preferably driven by an electronic controller that provides a period of rotation in one direction and then another period in at opposite direction. Of course any other rotational means such as manual work may be substituted for the reversible electric motor, according to local conditions.

This drawing does not show the mechanism for filling the hot mould with a sequence of materials in order to create a dense skin surrounding a lighter, thermally insulating centre. That sequence may be followed during the moulding process so that the fusible plastics particles or insulating materials that will form the centre do not mix with the different types of fusible plastics particles that will form the dense skin. Such a sequence was described in PCT/NZ2008/000096. For completeness we shall provide an example fusible plastics material. It is preferably a polyethylene plastics material; for example ICORENE 3840 made by ICO Polymers, Inc of the USA (example distributors: ICO Courtenay). This. is a Linear Medium Density Polyethylene plastic material. Various resins with different characteristics may be used, such as alloys based on the same ethylene with varied comonomer (hexene, butene or octene) raw materials, as is known to those skilled in the art. Such materials are obtainable in both solid-setting and foam-setting versions.

Design and construction of each specific three-dimensional shape or module should be directed to ensuring that the module can in fact be moulded inside a mould while rotating in a single-axis oven. The inventor has established that a variety of flat and more particularly bent three-dimensional shapes comprising two flat surfaces like a book that is not fully opened—see FIG. 2 for instances—and as a development, shapes in which the surfaces are not flat but curved, can be formed inside a single axis oven. During heating, the fusible granules move about the interior and cover the interior surfaces of the mould. The mould may be charged before use with an adequate amount of suitable plastics granules, and, by rotating the mould carrier during heating, all interior surfaces of the mould become coated to a sufficient thickness with adherent plastics, while the non-adherent granules move about and become stuck to a hotter surface thereby evening out the thickness of the coating. It is desirable that every part of the interior of the mould has a similar chance of trapping fusible granules, causing the granules to adhere at that point, and so build up a replica of the mould having a consistent thickness. One way to do this is to consider the flow of granules within while the mould is slowly rotated. If the various parts of the mould are at a similar distance from the axis, no part should receive an excess of granules. No part should be prevented from receiving a flow of fusible granules. The rotational moulding process is somewhat self-regulating, since an already well-coated portion of a mould does not transmit heat as fast as a thinner coated part, so that the thinner coated part receives more fresh fusible granules. A bent shape including two planes lying parallel up to an acute angle (FIG. 5: 501) has been found to be readily mouldable in a single-axis oven without the extra expense, size and complexity of a two-axis rotational moulding machine. A two-axis machine has the added disadvantage that the mould is closed during moulding hence it is not easy to introduce a different plastics material to fill the interior, as is preferred here in order to introduce a thermally insulating core.

Given such an oven, and given an end use for a rotational moulding process, one or a set of re-usable moulds may be designed and built in order to make parts capable of largely or completely satisfying the end use. A preferred means to join individual parts together at the time of assembly will be described later.

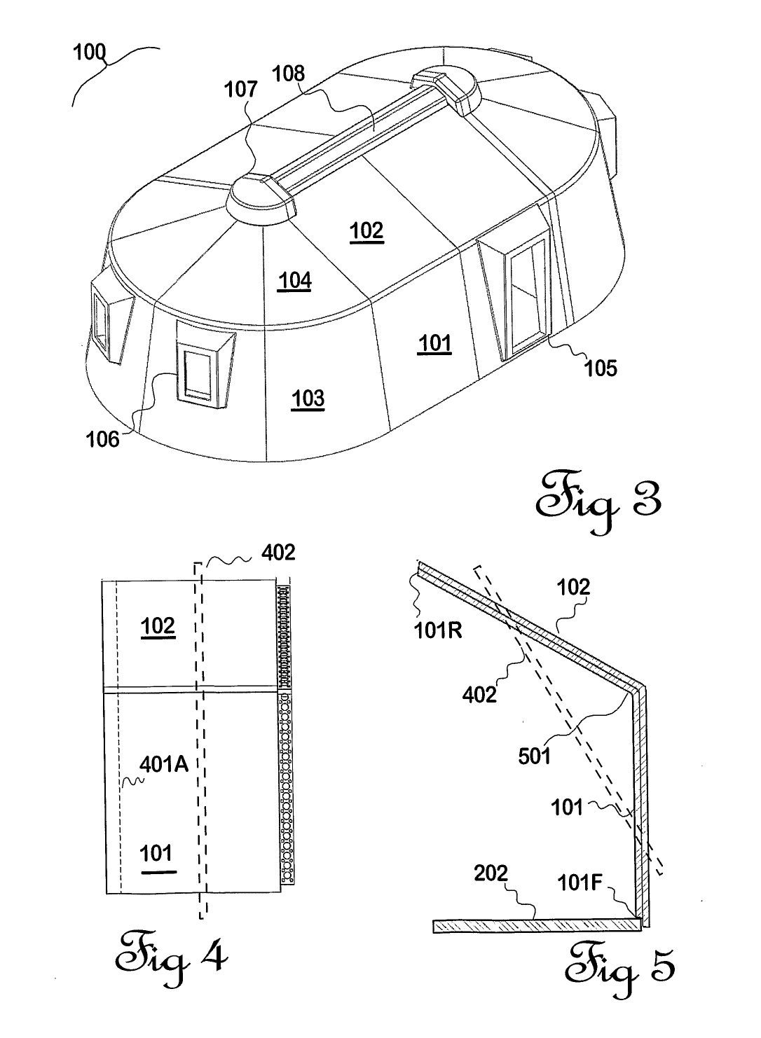

By way of example, we take a house of indefinite length; for example the specific house shown in FIGS. 2 and 3 and list the components as moulds in relation to the house drawings as follows:

Mould 1: Flat sided bent shape (combined as 101 and 102); no. required for house=3.

Mould 2: Flat sided bent shape (including part of rectangular door frame 105) no.=1.

Mould 3: Curved sided bent shape (combined as 103 and 104) no.=4.

Mould 4: Curved sided bent shape (including part of rectangular window frame 106) no.=4.

Mould (perhaps) 5: Straight shape forming roof cap member 108 no.=1. This particular item might be made by other means, such as of extruded metal or plastics, to properly provide for ventilation or admission of light). Its length may be extended if more side modules are used.

Mould 6: Circular form to mate with ends of roof apex and seal the ends; no=1. This one is sawn in half to make the two hemispheres.

We have found that it is not effective to make hollow rectangular outlines intended to serve as door frames or window frames within a single-axis oven, because the interior aspects of the outlines do not receive sufficient coating. Therefore such shapes are moulded as a pair of “L” shaped hollow outlines that are welded together by known plastic welding techniques in a jig after release and cooling from the rotational mould in order to make a rectangular hollow frame. Hence, two more moulds are required for the house Example:

Mould 7: Hollow L shaped rectangle mould for door frame no.=2.

Mould 8: Hollow L shaped rectangle mould for window frame no.=8.

See example 3 below for a description of related manufacturing methods for the flat floor 204, 205 and possibly for optional further outer layers for the flat and curved walls.

Any particular mould 20 is an openable, re-usable mould for making each specific desired shape, such as those shown in FIG. 2, for joining together in order to make a useful object. That object, in this Example, is a house or other building.

Each specific shape or module shown in FIG. 2 (an “exploded” view) and in FIG. 3, in which the parts are assembled as a house, has been created or designed under the two constraints (a) that it is capable of being properly moulded in a single axis mould of limited dimensions as described in this section, and (b) that it can be assembled together with others in order to make a large structure having utility. In contrast, our earlier application PCT/NZ2008/000096 related to a very large (by industry standards) capped cylindrical rotational mould capable of forming a round house with a roof in a single operation, but the round house was not able to be disassembled as for storage and transport in a shipping container, partially limiting applications for the house. Also, each house was rather heavy to move using manual labour. The components of the present invention can be carried separately or in small numbers on back packs.

After each mould is cooled and the module—the fused plastics replica of its interior is removed, the flanged edges that will become joinable to other modules are machined and drilled so that every joint complies with a mutual standard and may be joined to or removed from other modules in order to build or disassemble the resulting house example. See FIGS. 4, 6 and 9 and the related text for details.

The modules are then packed for storage and transport. They may be packed in sets in the numbers as given in the example above, for a single copy of the house as illustrated in FIG. 3, or stacked in bulk. The inventor's intention is that these buildings are suited for temporary accommodation such as in disaster or refugee relief.

### EXAMPLE 2

As shown in FIGS. 2 (exploded view) and 3 (assembled; perspective view) this invention provides by way of example a building 100 made of a plurality of modules—of which there are 7 types of module; not including roof ventilation components. For example this building may be about 3 metres high and be suited for temporary, emergency, or permanent use as a dwelling. The modular nature of the building includes the use of a first group of partially curved modules such as 103/104 to form each end of the building, and a second group of straight modules 101/102 to provide extra space between the ends (extra modules provide for a greater length). Two sets of two straight modules are shown here but more or fewer straight modules may be used in order to vary the length.

Despite the substance of Example 1, describing how the component parts are formed by rotational moulding, some of the parts of such a modular house might be formed by vacuum forming, or they might be made for example from a wood-based material (such as “particle board”—wood chips in a glue matrix) which is cured in a mould. Some of the parts may be made by one process and some by another. Optimal materials of course already exist for doors and windows themselves; possibly metal grilles rather than solid sheets, for hot climates.

With reference to thermal conductivity, each module is preferably initially formed by rotational moulding as a thick, hollow module perhaps 120 mm thick (externally) and has a perhaps 100 nun wide central cavity 604—the walls themselves (101, 602) being perhaps 8-10 mm thick. According to the single-axis invention, the insulating core may be added at a later stage of moulding through a conduit leading into the interior of the mould. The cavity of the mould is thereby filled, possibly even after the time of manufacture, with a thermally non-conductive material, for example “Aerogel™” or “Air foam” which foams up on release from a pressurised canister and sets into a hard foam. Those skilled in the arts will be aware of alternatives. A foaming type of PVC is available for use during injection moulding. Either foam can be applied so as to fill the interior of each moulded part, so that the thermal insulating quality (“R” value“) of the final house is optimal for hot or cold environments.

FIGS. 4 and 5 show as an example a plain, straight-wall three-dimensional module (101 with 102) which is broadly similar to the construction of a plain, curved-wall module (103 with 104) or one including a frame or at least a surface against which a separately made door or window frame may be fastened. In FIGS. 4 and 5, an imaginary axis of rotation 402 is shown as dashed lines for the apparatus as shown in FIG. 1 that made this module. No shaft actually penetrated the module. Two shafts sharing the same axis are connected to opposite sides of the framework 21A that supports the mould 21. One is driven by wheel 14; the other turns passively in a bearing or support. Either or both shafts may be made of steel pipe or the like and serve as a conduit for the introduction of fusible plastics materials. A conduit is not specifically illustrated here.

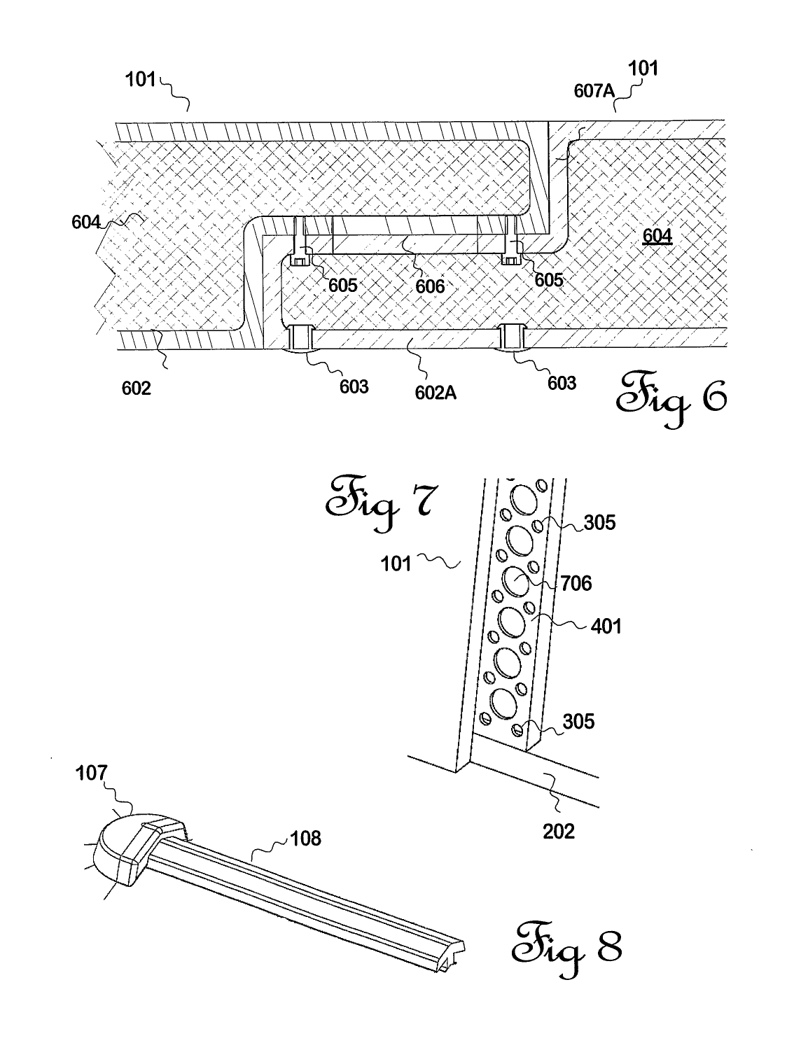

Modules as shown in FIGS. 2-5 include (a) a vertical or possibly slightly sloping wall section as 101, (b) a bend 501 leading to a more sharply sloping or roof section, (c) have an internal cavity as best shown in the cross-section of a joint in FIG. 6, preferably filled with thermally insulating material, (d) a lower edge 101F that adjoins a floor 202 or 203, (f) an upper edge 101R that adjoins a roof cap member 108 or the round end 107 on the cap, (g) a left-side jointing member 201, and (h) a right-side jointing member 202 by means of which adjacent modules may be connected together. FIG. 6 and FIG. 7 show details of one preferred type of simple joint which is compatible with plastics moulding techniques. This simple overlapping joint 401 is shown on one side of FIG. 4, and the position 401A of the complementary half is marked on the other side of FIG. 4 as dotted line 401A. The joint is also shown in section in FIG. 6, as 606 which is contiguous with the remainder of the module 101 or 101A. A flange 401 is perforated with holes 706 so that thermal conductivity through the solid plastic of the joint is minimised. Other holes 305 are pre-drilled for penetration by screws. The corresponding left-side flange is of course fabricated to fit neatly against the flange 401/606.

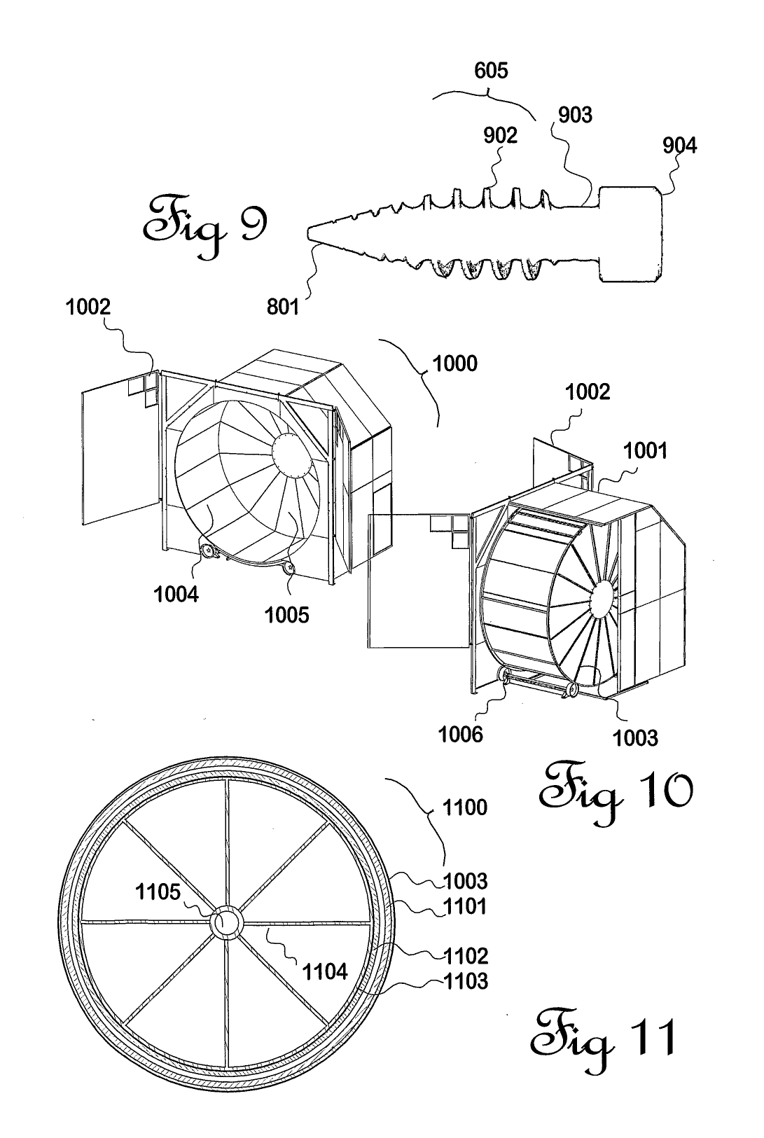

An example connection means is shown in FIG. 4. Once adjoining modules are lined up, a screw, snap, or like, preferably removable fastener 605 is pushed from the inside, through aperture 305 in the inner wall and through the mating portions of the joint and tightened so as to fasten the two parts together. As can be seen in FIG. 4 or 7 there are many sites provided. A specially optimised screw is shown in FIG. 9. A screw fastener, as opposed to adhesives or welding is preferred in the case of houses that are likely to be disassembled and stored again for another disaster. A typical example screw is 60 mm (2.5 inches) long, It has a head 904 including a hexagonal socket for use with a matching Allen key; a washer may be provided under the head or the head itself may be spread out to provide a wider bearing surface; a body bearing an exaggerated thread 902, and a pointed end 901 which is intended to find its way into a hole 305 during use and then the threads will tap into the sides of the hole, so pulling and holding the two halves of the joint together as shown in FIG. 6. Note in FIG. 6 that each half of the overlapping joint is adequately covered by a layer of insulation 604. Plugged holes 603 are used to gain access to the screw heads and insulation is preferably placed over the bolt heads before the plugs are inserted. If the invention is to be used in Arctic conditions such as −40 degrees Celsius blizzards, it is preferable to completely seal all apertures against wind-blown snow because otherwise the building may in time become filled with snow. Also, air leaks lose heat so should be sealed. There may be some movement of heat through the transverse parts of the lap joint 607A which is designed to provide a long total path for heat to travel and holes 706 are a further partial barrier.

In this preferred embodiment, the curved modules 103, 104 that form an end of a building are shaped with tapering roof sections so that four of them may be abutted against each other and form a hemicircular end wall. If four sections form a 180 degree circle, then each roof section 104 includes a 45 degree angle. Clearly, other numbers ranging from one to perhaps 6 or 8 modules may be used instead, with appropriate choices of shapes and relative dimensions.

For use in adverse environments, the windows 106 (if any) are at least double-glazed if not triple-glazed, so that heat loss is reduced. The door itself should include thermal insulation and all seals around openable doors, windows and ventilation apertures should be capable of being closed. Of course, if a fire (including an oil or gas heater) is to be used inside the building, effective ventilation is required in case of carbon monoxide poisoning and to supply oxygen.

The roof cap elements 107, 108 in FIG. 7 cover the upper edges of modules and provide a weatherproof seal. A version having an openable ventilation aperture is not shown, but is a disable option since hot or smoke-laden air that tends to rise should be allowed to escape in all but the coldest climates. The upper edges 603 of the modules are also provided with a joint structure as described previously in this section, so that they may be rendered weathertight against each other, or against the roof cap elements. The roof cap elements could be made of clear plastics material for internal lighting purposes.

### EXAMPLE 3

In some circumstances, a floor is not essential, but in other circumstances the house may be used in hot or cold areas or placed on piles and then a substantial, and insulated floor is required. In order to reduce heat loss through the floor the floor may include a foamed cavity, and it may be laid down upon a foamed polystyrene sheet. Heat loss through the floor may melt underlying ice or permafrost, apart from the comfort aspects of a cold floor.

The half-circular floor elements shown as flat sheets in FIG. 2 as 204 may be made of the same plastics fusible material, according to the general principles of the invention in a circular flat rotational mould orientated with a vertical axis of rotation and then cut in half, or the mould may include a divider. Such a moulding oven and mould were fully described in PCT/NZ2008/000096.

There is a further requirement to make rectangular floor components each having a hard surface and a thermally insulating core, as for the components previously described in this section. With reference to FIG. 10, a variant of the horizontal-axis large rotary mould inside a shrouding oven that was described in PCT/NZ2008/000096 is shown at 1000. This variant may for example be dimensioned so that it has a circumference of just over 3 metres and a depth of just over 3 metres; to provide a 3 m×3 m rectangle of floor material. A five metre diameter mould is preferred and even larger sizes may be feasible. Standard sizes like 2.4 metres×2.4 metres or multiples thereof may instead be preferred. This variant is operated in the previously described manner in which heat is generated inside a shroud 1001 and outside a mould 1003, with the doors 1002 closed. Fusible plastics material as previously described is blown in and over the surface 1004, where the material sticks, or slides then sticks and fuses together with the heat. The mould is continually yet slowly rotated upon the driving wheels 1006. In this case, no fusible plastics material is thrown on to the far end wall 1005, so that an open-ended cylinder having the dimensions of the interior of the heated cylinder, and a desired thickness, is formed. The plastics material used may be varied during the heating process so that an exterior hard skin is supported by a more foamy interior for the purposes of insulation and another hard layer may be applied last. At the end of a moulding process, the doors 1002 of the oven are opened and a fork-lift truck (not shown) supporting a spoked (1104) carrying frame as shown in FIG. 11 upon a tube within the axis 1105 over a fork included on its carriage is driven up, and the frame is lifted and tilted so that the frame enters the oven 1003. When the cooling plastics cylinder shrinks as it cools, and releases itself from the mould walls, the cylinder falls on to the frame. The frame then supports the cylinder. Now, the fork lift is reversed and used to bring the still hot and soft cylinder to a flat cutting table or floor. The cylinder is cut par-axially and the ends fall or may be rolled on to the cutting table, for trimming to a desired size or for “fettling” of rough parts. The now flat sheet is left on the table to cool and harden. In the event that curved sheets are required for extra covering of the house exterior, for example, one option is that the cutting table bears the desired curve (which may be in two dimensions) and the hot plastics sheet is allowed to slump into place. Alternatively the dimensions of the frame are such that the cylinder has the desired curve and it is left to cool on the frame and is later cut apart. This method has an advantage over the vertical axis machine of PCT/NZ2008/000096 that the resulting shapes are substantially rectangular.

The one cross-sectional drawing of the frame 1100 includes two states of the plastics cylinder. The outermost hatched circle represents the mould 1003. The next hatched circle 1101 represents the hot plastics cylinder in contact with the mould. The next hatched circle 1102 represents the cooler and shrunken but still hot plastics cylinder now in contact with the exterior drum or bands 1103 of the frame. That exterior drum is supported on spokes 1104 from a central hub 1105 which accepts a fork or a shaft or the like mounted on the carriage of the fork lift truck. It may be convenient to build rails into the floor outside the oven so that the truck is guided into the correct position, and it may be desirable to shield the operator from the heat and fumes coming out of the oven or from the hot cylinder.

### VARIATIONS

Optionally of course a floor could be made of some other material, like wood, familiar to persons skilled in the building arts. Dividing walls inside each house are outside the scope of this specification, although free-standing modules 101/102 might be placed on their angled edges as partitions. Possibly, snow loading may become a requirement for an internal support of the roof cap members 107, 108.

Extra mouldings may be applied over the modules shown, with intermediate insulation layers such as foil-backed tarred paper.

To make a larger floor plan area, the simple approach is to lengthen the building. Another approach which would widen the building is to alternate curved end-sections (103/104) with straight sections (101/102) and devise an appropriate wide end cap to replace the cap 107.

Adjacent buildings may be joined together by means of the door module and a tunnel. A tunnel outside, or inside, the closable door would allow for storage of wet or frozen clothing, frozen foods, or the like. Outside tunnels may be made of locally available materials, while an inside-the-door tunnel may require a further module.

Apart from rotational moulding, the modules may be made by vacuum-forming inner and outer surfaces separately from a thermoplastics sheet material, then filling the cavity, then adhering the inner and outer walls together. Or they may be made from fibreglass applied against a form covered with a release agent. Fibreglass may be used for repairs.

### INDUSTRIAL APPLICABILITY AND ADVANTAGES

The manufacturing apparatus provides easily managed moulds, ovens and mould supports for use in rotational moulding which operate on a single axis only, yet which are capable of creating useful products either if used alone or as modules for a more complex assembly. The apparatus does not require mechanical complexity such as that required for holding dies from gimballed pivots in a large heated space.

The invention provides an erectable, demountable building made of perhaps 12 separate modules which may be shipped or stored in the disassembled state and then erected by untrained personnel on a site, using screwdrivers or the like. It is believed that rotational moulding is a cheaper fabrication method than most other options for making such modules. The teachings herein allow such buildings to be made in places far from technical sophistry. Indeed, after a disaster, support services such as electricity may not be available; nor may there be anybody available who can work a high-technology solution or even have basic skills such as carpentry.

Finally, it will be understood that the scope of this invention as described by way of example and/or illustrated herein is not limited to the specified embodiments. Where in the foregoing description, reference has been made to specific components or integers of the invention having known equivalents, then such equivalents are included as if individually set forth. Those of skill will appreciate that various modifications, additions, known equivalents, and substitutions are possible without departing from the scope and spirit of the invention as set forth in the following claims.

1. Apparatus for making components by rotational moulding of a granular, flowable, fusible plastics material with heat in a mould in an oven characterised in that the apparatus includes single-axis rotational means only, and includes at least one mould rotatable when in use inside a heatable oven in a single axis, the mould being supported in a frame and having a mould interior shaped so as to be capable of forming a three-dimensional component; the shape of the interior of each mould, in combination with a selected axis of rotation, being calculated and controlled so that all parts of the interior of the mould have a substantially similar chance of receiving a coating of the fusible plastics material despite the restriction to single-axis rotation.

2. Apparatus as claimed in claim 1, characterised in that the position of the axis of rotation is adjusted with regard to the internal shape of the mould so that the distance that the granular material may flow from the axis of rotation to any extremity of the mould is similar.

3. Apparatus as claimed in claim 1, characterised in that the mould includes at least one axial conduit capable of receiving the granular fusible plastics material while the mould is undergoing rotation, in order that further material, or material of a different composition, may be introduced into the mould after rotational moulding has commenced.

4. Apparatus as claimed in claim 1, characterised in that the mould or family of moulds are shaped so as to produce thin moulded three-dimensional components having a first flattened area merged along an edge into a second flattened area occupying a different plane; each flattened area being thin yet including a contiguous thermally insulating core; the core being surrounded on every side by an impervious layer.

5. Apparatus as claimed in claim 4, characterised in that the flattened areas of at least some of the components are curved areas.

6. Apparatus as claimed in claim 4, characterised in that one flattened area of at least some of the components includes a framed rectangular aperture.

7. Apparatus as claimed in claim 4, characterised in that the mould or family of moulds are shaped so as to provide thin moulded three-dimensional components each having complementary interconnecting means along at least two opposite edges, said inter connecting means of any one component being capable of becoming fastened to the interconnecting means of other compatible components.

8. Apparatus as claimed in claim 7, characterised in that the interconnecting means comprises a complementary pair of lapped joints.

9. Apparatus as claimed in claim 7, characterised in that the mould provides a moulded component selected from a range including (a) a plain, straight-wall module, (b) a plain, curved-wall module, (c) a straight-wall module including a door opening, (d) a straight-wall module including a window opening, and (e) a curved-wall module including a window opening; the range providing components capable of being assembled together by interconnecting means.

10. A building, characterised in that the building is made using assembled, moulded components each manufactured according to claim 9.

11. Apparatus for making components by rotational moulding of a granular fusible plastics material with heat in an oven characterised in that the apparatus includes single-axis rotational moulding means only; the mould comprises a cylindrical shape capable of being rotated about the axis of the cylinder when inside the closed, heated oven and thereby forming a cylindrical fused mass from introduced fusible granular plastics material; the apparatus also including removal means comprising a moveable cylindrical frame capable of carrying, supported by the exterior of the cylinder, a formed cylinder of plastics material away from the oven whereupon the cylinder may be cut apart while hot and laid flat before cooling takes place.

12. Apparatus as claimed in claim 5, characterised in that one flattened area of at least some of the components includes a framed rectangular aperture.
